(19) United States
(12) Patent Application Publication
(10) Pub. No.: US 2016/0009364 A1
(43) Pub. Date: Jan. 14, 2016

(54) Fluid Boundary Layer Control

(71) Applicant: VIRES Aeronautics, Inc., Livermore, CA (US)

(72) Inventor: Harshil Goel, Berkeley, CA (US)

(73) Assignee: VIRES Aeronautics, Inc., Livermore, CA (US)

(21) Appl. No.: 14/187,260

(22) Filed: Feb. 22, 2014

Related U.S. Application Data
(60) Provisional application No. 61/768,412, filed on Feb. 23, 2013.
(60) Provisional application No. 61/900,721, filed on Nov. 6, 2013.

(51) Int. Cl. B64C 3/14; B64C 1/38; B64C 23/08

(52) U.S. Cl. CPC B64C 3/141; B64C 23/08; B64C 1/38

(57) ABSTRACT

The lift and drag performance of all vehicles is strongly influenced by viscous effects, and in turn, laminar separation bubbles. This application employs an effective fluid boundary layer control strategy that reduces parasitic drag, allows for more usable angles of attack, and delays or stops separation. In the approach of this application, the control surface effectively uses the Magnus effect to delay or stop a separation bubble from forming, which can increase lift, reduce drag, and delay degrees of stall by directly manipulating the velocity gradient in the fluid boundary layer.

### PRIORITY CLAIM

This application claims the benefit of priority from U.S. Provisional Patent Application Ser. No. 61/768,412, entitled “VIRES Control Surface” and filed Feb. 23, 2013, and also claims the benefit of priority from U.S. Provisional Patent Application Ser. No. 61,900,721, entitled “Fluid Boundary Layer Control” and filed Nov. 6, 2013, both of which are fully incorporated herein by reference for all purposes to the extent permitted by law and not inconsistent with this application.

### BACKGROUND

1. Field of the Application

The disclosure is directed to fluid mechanics and, more particularly, to controlling a fluid boundary layer of an object in a fluid medium.

2. Background of the Disclosure

Virtually all aspects of daily life involve fluids and things that move through fluids. Air and water are the two most dominate fluids on the planet, through which most things move. A thin layer of fluid surrounding an object is generally referred to as a fluid boundary layer, which can include a layer of particles of the fluid having the closest proximity to the object. This layer of closest proximity particles can have a significant influence on the objects behavior in the fluid medium. Manipulation of fluids and fluid boundary layers is the focus of much scientific and engineering research, such as, for example, the fluid-dynamics of vehicles design to made them more efficiency and/or more economical to build and operate. In this context, fluid-dynamics might include aerodynamics, hydrodynamics, and the like. Often, design geometries of such vehicles are manipulated to alter or adjust their behavior while moving through the fluid.

Examples of geometric manipulation methods for controlling the fluid boundary layer in the field of aviation or wing/airfoil aerodynamics include vortex generators, leading edge slots, turbulators, and so on. These geometric methods rely on equalization of pressure over different parts of an aircraft wing, or purposely inducing vortices and/or turbulence in order to delay boundary layer separation. Testing in these areas suggests that boundary layer separation effects are reduced in a turbulent fluid regime relative to a laminar regime.

Blown flaps and boundary layer suction are examples of active pressure manipulation to control the boundary layer of a wing. These methods rely on either blowing or sucking air out of slits in order to facilitate boundary layer control. An example of velocity manipulation is the cyclo-gyro called the Fan Wing developed by Patrick Peebles in 1997 in the UK. Peebles' method involved mounting one large cylinder on the leading edge of a wing to induce boundary layer control.

Referring to FIG. 1 and FIG. 2, a boundary layer of fluid forms when solid objects travel through fluids. Using Prandtl's analysis, viscous forces start to have affect in the boundary layer. FIG. 1 illustrates a laminar boundary velocity profile 100 of an object in a fluid medium. As shown in FIG. 1, in front of and at the leading edge of the object, u₀, the fluid velocity is generally consistent as a function of the distance away from the surface of the object. That is, no-slip condition forces are prevalent at the leading edge surface of the object. However, at a point some distance over the object (i.e., downstream from the leading edge of the object), u(y), the fluid velocity if no longer consistent as a function of the distance away from the surface of the object. As shown in FIG. 1, at u(y), the fluid velocities nearer to the object are lower than the fluid velocities away from the object (i.e., the free-flow fluid velocities).

FIG. 2 illustrates behavior of a fluid flow after separation. As shown in FIG. 2, in the field of aviation, flow separation occurs when the adverse pressure gradient, namely the difference between pressure at the back of the wing and the front of the wing of an aircraft, is large enough to slow the fluid velocity at the boundary layer to 0. Boundary layer separation occurs when the velocity in the boundary layer reverses (i.e., becomes negative with respect to the free-flow stream velocity). The fluid flow after separation, detaches from the surface of the object and forms eddies and vortices, engendering pressure drag due to the pressure differential between the leading and trailing edges. Additionally, low separation creates pressure drag and effectively, the perceived airfoil shape. The tendency for the boundary layer to separate depends on an adverse velocity gradient, which is related to an adverse pressure gradient.

In the book “Boundary Layer Theory” by Dr. Hermann Schlichting ISBN: 0-07-055334-3, it is clearly stated on page 379 and 380 that “the idea of moving the solid wall with the stream can be realized at the cost of very great complications as far as shapes other than cylindrical are concerned, and consequently this method has not found much practical application.” As will be shown throughout this application, there is indeed a simple method to control boundary layer separation and fluid flow over a surface using moving structure(s).

### BRIEF DESCRIPTION OF THE DRAWINGS

FIG. 1 illustrates a laminar boundary velocity profile of an object in a fluid medium.

FIG. 2 illustrates behavior of a fluid flow after separation.

FIG. 3 illustrates a ball in a fluid medium showing the Magnus Effect.

FIG. 4 illustrates an exemplary device to control flow at a fluid boundary layer according to certain embodiments.

FIG. 5 illustrates an exemplary housing according to certain embodiments.

FIG. 6 illustrates an exemplary rotational belt and rods according to certain embodiments.

FIG. 7 illustrates an exemplary pair of endplates according to certain embodiments.

FIG. 8 illustrates an exemplary side view of the rotational belt according to certain embodiments.

FIG. 9 is an exemplary isometric view of an endplate according to certain embodiments.

FIG. 10 illustrates exemplary alignment holes, which align with cylindrical holes of an aircraft wing housing, according to certain embodiments.

FIG. 11 illustrates an exemplary assembly of bearings inserted into an endplate, coupled to aircraft wing housing, according to certain embodiments.

FIG. 12 illustrates an exemplary relationship between rods, bearings and an endplate according to certain embodiments.

FIG. 13 illustrates an exemplary endplate and rods according to certain embodiments.

FIG. 14 illustrates an exemplary device before and after actuation of a rotational belt according to certain embodiments.

FIG. 15 illustrates an exemplary variation of the linearized pressure coefficient with Mack number according to certain embodiments.

FIG. 16 illustrates an exemplary comparison between linearized theory and exact results for pressure on a wedge in supersonic flow according to certain embodiments.

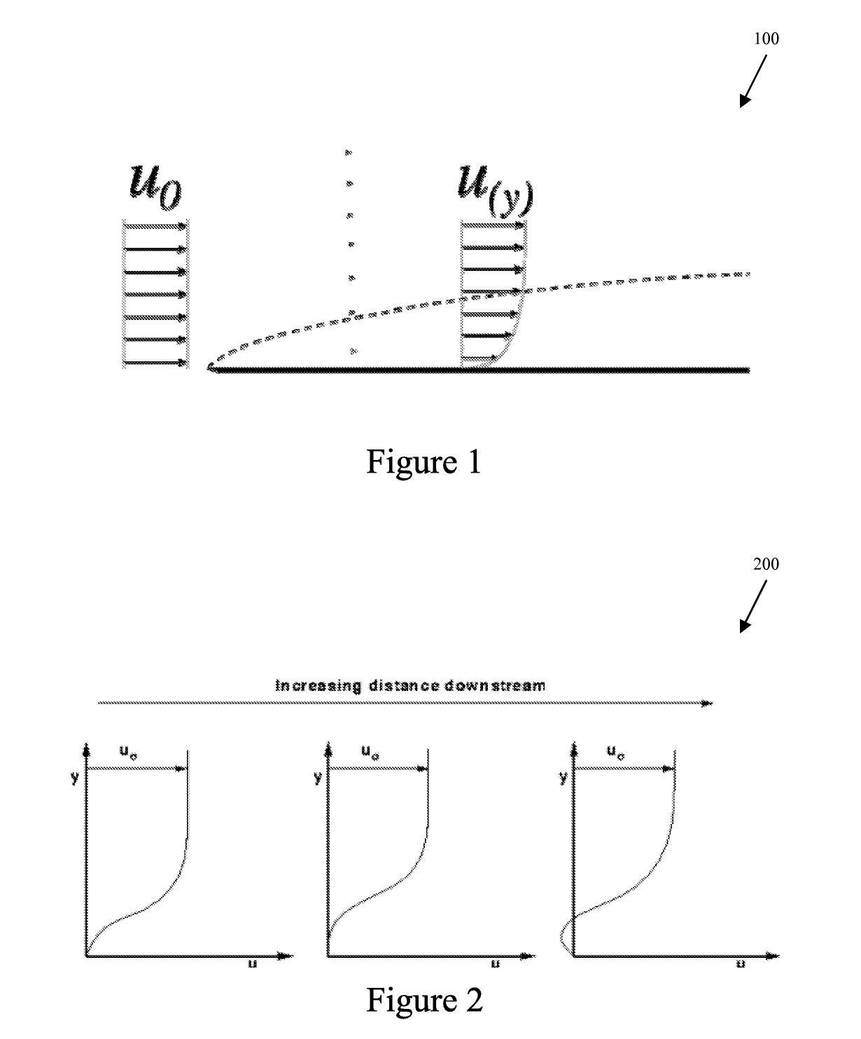

### DETAILED DESCRIPTION

The following detailed description is directed to certain embodiments. However, the disclosure can be embodied in a multitude of different ways as defined and covered by the claims. In this description, reference is made to the drawings wherein like parts are designated with like reference numerals within this application.

This application is in the technical fields of fluid dynamics (e.g., including aerodynamics, hydrodynamics, etc.), thermodynamic and acoustic control, specifically pertaining to objects as they move through a fluid and the control and/or manipulation of the boundary layer between the objects' surfaces and the fluid, as well as compressible flows (e.g., high-speed flow). The lift and drag performance of all objects moving through a fluid is strongly influenced by viscous effects, and consequently, laminar separation bubbles. In some aerospace embodiments, the proposed teachings employs an effective boundary control technique that reduces parasitic drag, allows for more usable angle of attacks, delays/stops the separation, increases the lift, and allows for more maneuverability. In addition, the techniques described herein can affect the thermal boundary layer allowing for forced convection, and other types of thermal control because the constitutive equations that govern both fluid and thermal systems are understood to be coupled.

In the context of this application, a fluid can be air, including space, or any liquid fluid, such as ocean salt water or river/lake fresh water. The objects covered by this application are intended to be any type or size of object capable of moving through a fluid or having a fluid move over, around or through it, such as, for example, an unmanned aerial vehicle (UAV), airplane, helicopter, spacecraft or other fixed-wing or non-fixed-wing aircraft, a jet engine, a boat, yacht, ship, tanker, barge, submarine, or other above-water or under-water vehicle, a car, semi-truck and trailer, bus, motorcycle or other land-based vehicle, a windmill, building exterior, oil well structure, or other similar stationary or quasi-stationary object with fluid moving past it, or any combination of these.

### Overview

In certain embodiments, a control surface (boundary layer device) circumvents conventional means of geometric optimization, for example, by changing pressure through a device that controls the fluid boundary layer. This device can change the velocity gradient as the object moves through the fluid, by changing the boundary conditions at the surface of at least a portion of the object in the fluid, such as for example an aircraft wing moving through air. This proposed boundary layer manipulation is justified by differential equations that govern the corresponding control surface (and discussed in more detail elsewhere in this disclosure). In this application, certain embodiments are described in the technical field of aerospace engineering, unmanned aerial vehicles, air passenger vehicles, and other air transport crafts, specifically pertaining to fluid boundary layer control or manipulation. It will be appreciated by those skilled in the art, that the teachings of this application may be applied to any object moving through any fluid (and/or vice versa), all of which are intended to be within the scope and spirit of this application.

Aircraft efficiency can include the following three categories: lift per unit span, overall drag, and stall angle of attack. All of these categories are affected by fluid separation on the wing. For example, stall occurs when the fluid is completely detached from the surface. Lift and drag performance in aircrafts is strongly influenced by viscous effects, and consequently, laminar separation bubbles. This disclosure employs an effective boundary control strategy that can reduce parasitic drag, allowing for more usable angle of attacks, and delays/stops the separation. Improving these characteristics by manipulating the boundary layer effects can result in one or more of decreased amounts of fuel used, increased support for additional payloads, increased maneuverability, improved flight paths, and so on. Certain embodiments disclosed herein can manipulate the relative velocity of the object seen by the fluid. This essentially “tricks” the fluid into believing the object is moving with a different prescribed velocity than the overall body of the object is actually moving. For example, if the object is moving at 5 meters per second (m/s) through a stationary fluid medium and a surface of the object is moving at 5 m/s in the opposite direction to that of the moving object, then the fluid effectively sees a static object or a relative velocity of 0. This can also affect or change the shear stress characteristics of the fluid.

Certain embodiments of this application might include, for example, boundary layer control without induced drag, enhanced performance by changing lift per unit span, improved angles of stall, and minimized power usage. The proposed technology additionally employs a traditional control surface (ailerons, elevator, rudder, etc.) that de-ices the wings, removes debris from the wings, and allows for complicated maneuvers. The techniques of this disclosure remove traditional reliance on geometry or active pressure sucking/blowing for boundary layer control. It also has the ability to increase lift while reducing drag (i.e., devices traditionally sacrifice one to improve the other). The proposed technology also serves as a form of thermodynamic control and/or acoustic control on a surface of the vehicle where the technology is deployed (and thus, for the vehicle as a whole).

The same or similar analyses can be applied to other objects moving through other fluids (and vice versa), where lift and drag are abstracted to forces on the object vis-à-vis the fluid, such as for example in a passenger car, a windmill, a boat or a submarine. Reducing the fluid separation can increase the overall drag-related efficiency on any object in any fluid. It can also allow for force control in any object in any fluid, for example upward forces in aquatic vehicles, down force and traction related phenomenon on land vehicles and blade forces of a windmill. Similar analysis can be extended to objects moving through a fluid with a high speed. A characterization of this type of flow is a compressible flow.

As mention earlier control of a fluid boundary layer can be coupled with control of a thermal boundary layer. The equations that govern these two boundary layers share variables, and formats (as discussed in more detail elsewhere in this application). In this way, for example, an object reaches its minimum convective constant at separation.

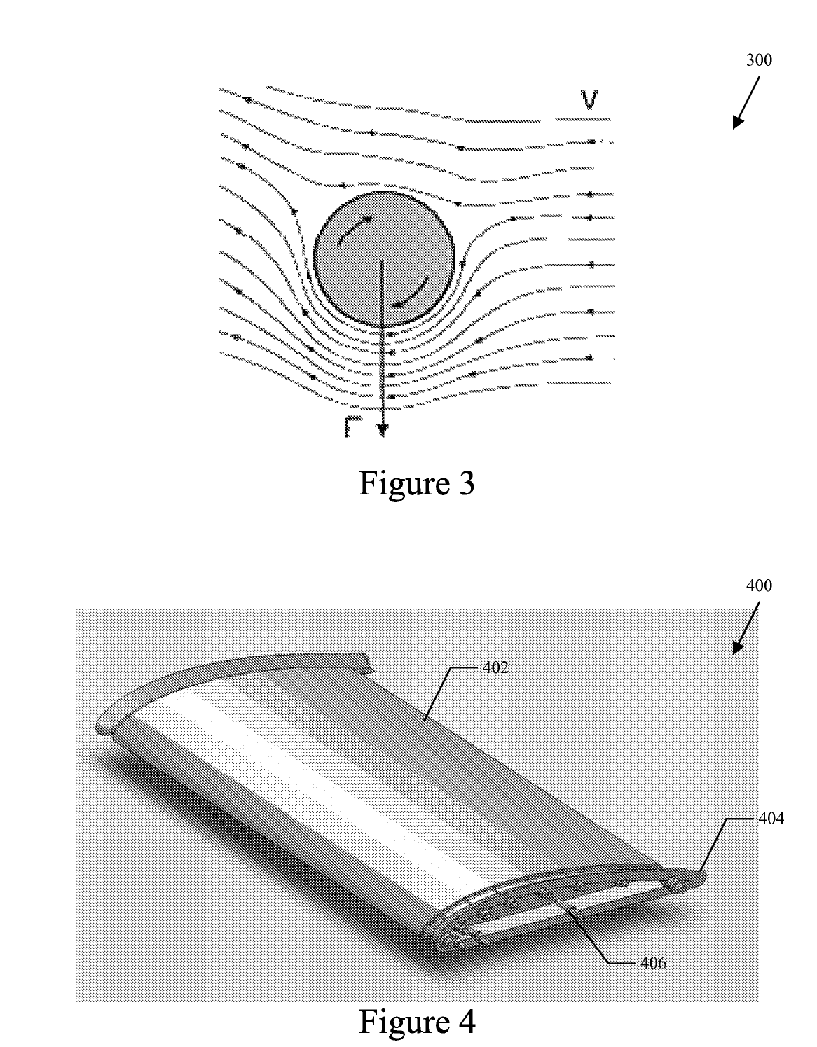

FIG. 3 illustrates a ball in a fluid medium showing the Magnus Effect. The Magnus Effect explains that a spinning object in a fluid experiences a force perpendicular to the line of motion. This application introduces a variation of the Magnus Effect by manipulating the no slip condition (U=0 at y=0). In certain embodiments, the no slip condition, a geometric tangential velocity at the surface of an aircraft wing is now variable, effectively giving control of the differential equation that governs boundary layer flow. This lifting force is induced by increased circulation, which is created by mechanical rotation. In a stationary object, such as an airfoil, the V at the surface is zero, due to the no-slip condition, and steadily increases in a parabolic shape until it achieves free-flow stream velocity. In the case of a rotating body, the surface velocity is the tangential velocity of the rotating body rather than equal to zero, thus causing a flatter velocity profile, similar to that of the free-flow stream velocity.

In summary, this application is meant to serve as a system that fundamentally changes how fluid flow over an object is perceived, governed, designed and/or implemented. In certain embodiments, at least portions of this disclosure can change the traditionally assumed no-slip condition at the surface of an object moving in a fluid. This change can allow control of the boundary condition that governs the dynamics involved in boundary layer flow. In certain embodiments, at least portions of this disclosure can change how the engagement of this system can macroscopically alter the effective relative velocity of the aircraft (or other vehicle or installation) to the moving fluid. This disclosure can change, in aerodynamics, the C_l, C_d, C_m, V_rel and/or v(y)=v(0) terms in all equations in all constitutive theories concerned with fluid flow over an object (C_l, C_d, C_m are constants traditionally used in aerodynamic analysis, specifically, analogue variables exist for equations governing fluid flow in other mediums with other vehicles, the variables are simply labeled colloquially; for example, the term traditionally used for the boundary layer separation bubble, is commonly referred to as the slip stream in aquatic vehicles).

By controlling at least all of the variables mentioned in the paragraph above, this application can control the lift, drag, stall, boundary separation, and maneuverability characteristics in vehicles or objects moving through a fluid. A variable control of the above-variables can enable unprecedented control of the object, and can allow the object to adapt to different scenarios that the object may face. Control of these variables explicitly increases the cargo capacity, top speed, fuel consumption, maneuverability, and decreases the takeoff and landing time of the craft at hand. The fact that no slip condition is changed implies that the velocity gradient profile described above is changed. This change can allow for control of whether and when fluid flow separation might occur. Fluid flow separation occurs where the velocity gradient reverses direction. The structural movement with or against the fluid flow, as defined throughout this application, can force the local velocity of the aircraft to be greater and can increase the amount of drag/friction required to slow the fluid locally enough to reverse direction.

In certain embodiments, delay of fluid separation is an exemplary way this disclosure can increase the aerodynamic/hydrodynamic characteristics of an object. Removal of the separation bubble can reduce the drag, can increase the lift and can allow for a delay in stall angle. It should be noted that this overview is provided with the utmost generality relative to the certain embodiments of this application, and therefore the new technique(s) can be implemented on any surface of any object exposed at any point in time to a fluid medium through which it is travelling, i.e., fuselages, hulls, wings, flaps, spoilers, ceilings, blades, under carriages, doors, wind shields, mirrors, hoods of cars, and so on. All of the above (and more) potential installations can experience various aero/hydrodynamic forces because they are exposed to the fluid medium through which they are moving, and therefore are surfaces where certain embodiments of this application can implemented to control the aero/hydrodynamic parameters involved that govern the respective flows.

Certain embodiments of this application are equally applicable to low speed and high speed applications/installations. For example, in a high speed application, compressible effects in a fluid are not negligible. In a high speed application, certain embodiments could reduce the boundary layer separation bubble and wave drag and could reduce the effective relative velocity of the craft in regions of the craft where the relative velocity is near or approaching Mach 1. The result of this technique could be to increase the critical Mach number and the drag divergence Mach number. These numbers are used to determine when the craft moving through a fluid will start to experience exponentially large increase in drag. These numbers also indicate the formation of transonic separation and shocks in the fluid boundary layer. Certain embodiments can help minimize such shocks/separation and prevent/delay their formation, in addition to, more generally, the notion of shock control in either aircraft and/or jet engines. Such an installation might require a special control scheme(s), such as described elsewhere in this application.

### Boundary Layer

The boundary layer is derived from Navier-Stokes equations of viscous fluid flow. The characteristic of partial differential equations becomes parabolic, which extensively simplifies the solution of the equations. Under the boundary layer approximation, the flow divides the equation into an inviscid portion and the boundary layer portion, which is governed by a solvable partial differential equation. The continuity and Navier-Stokes equations for a two-dimensional steady incompressible flowing Cartesian coordinates are as follows:

$$\frac{\partial u}{\partial x} + \frac{\partial υ}{\partial y} = 0$$

$$u \frac{\partial u}{\partial x} + υ \frac{\partial u}{\partial y} = - \frac{1}{ρ} \frac{\partial p}{\partial x} + v ( \frac{{\partial }^{2} u}{\partial {x}^{2}} + \frac{{\partial }^{2} u}{\partial {y}^{2}} )$$

$$u \frac{\partial υ}{\partial x} + υ \frac{\partial υ}{\partial y} = - \frac{1}{ρ} \frac{\partial p}{\partial y} + v ( \frac{{\partial }^{2} υ}{\partial {x}^{2}} + \frac{{\partial }^{2} υ}{\partial {y}^{2}} )$$

in which and u and v are the velocity components, ρ is the density, p is the pressure, and ν is the kinematic viscosity of the fluid at a point.

The boundary layer approximation shows that for a sufficiently high Reynolds number, the flow over a surface can be divided into an outer region of inviscid flow unaffected by viscosity, and a region close to the surface where viscosity is important, namely the boundary layer. u and v are stream-wise and transverse velocities, respectively, inside the boundary layer. By employing scale analysis, the aforementioned equations of motion reduce within the boundary layer to

$$\frac{\partial u}{\partial x} + \frac{\partial υ}{\partial y} = 0$$

$$u \frac{\partial u}{\partial x} + υ \frac{\partial u}{\partial y} = - \frac{1}{ρ} \frac{\partial p}{\partial x} + v \frac{{\partial }^{2} u}{\partial {y}^{2}}$$

and if the fluid is incompressible

$$\frac{1}{ρ} \frac{\partial p}{\partial y} = 0$$

The asymptotic analysis also shows that v, the wall normal velocity, is small compared with u, the stream-wise velocity, and that variations in properties in the stream-wise direction are generally much lower than those in the wall normal direction.

Since the static pressure p is independent of y, pressure at the edge of the boundary layer is the pressure throughout the boundary layer at a given stream-wise position. The external pressure is derived through Bernoulli's equation. u₀ is the fluid velocity outside the boundary layer, and u and u₀ are both parallel. When substituting for p the equation reads

$$u \frac{\partial u}{\partial x} + υ \frac{\partial u}{\partial y} = {u}_{0} \frac{\partial {u}_{0}}{\partial x} + v \frac{{\partial }^{2} u}{\partial {y}^{2}}$$

with the boundary condition

$$\frac{\partial u}{\partial x} + \frac{\partial υ}{\partial y} = 0$$

for a flow in which the static pressure p does not change in the direction of the flow then

$$\frac{\partial p}{\partial x} = 0$$

thus u₀ remains constant.

Therefore, the equation of motion simplifies to become

$$u \frac{\partial u}{\partial x} + υ \frac{\partial u}{\partial y} = v \frac{{\partial }^{2} u}{\partial {y}^{2}}$$

These approximations are used in a variety of practical flow problems of scientific and engineering interest. The above analysis is for any instantaneous laminar or turbulent boundary layer, but is used mainly in laminar flow studies since the mean flow is also the instantaneous flow because there are no velocity fluctuations present.

### Thermal Boundary Layer

Paul Richard Heinrich Blasius derived an exact solution to the above laminar boundary layer equations. The thickness of the boundary layer δ is a function of the Reynolds number for laminar flow.

$$δ \approx \frac{5.0 * x}{\sqrt{Re}}$$

where δ=the thickness of the boundary layer: the region of flow where the velocity is less than 99% of the far field velocity v_{∞}; χ is position along the semi-infinite plate; and Re is the Reynolds Number given by ρv_{∞}χ/μ(ρ=density and μ=dynamic viscosity).

The Blasius solution uses boundary conditions in a dimensionless form:

$$\frac{{υ}_{x} - {υ}_{S}}{{υ}_{∞} - {υ}_{S}} = \frac{{υ}_{x}}{{υ}_{∞}} = \frac{{υ}_{y}}{{υ}_{∞}} = 0$$

at y=0

$$\frac{{υ}_{x} - {υ}_{S}}{{υ}_{∞} - {υ}_{S}} = \frac{{υ}_{x}}{{υ}_{∞}} = 1$$

at y∞ and χ=0

Note that in many cases, the no-slip boundary condition holds that v_{S}, the fluid velocity at the surface of the plate equals the velocity of the plate at all locations. If the plate is not moving, then v_{S}=0.

In fact, the Blasius solution for laminar velocity profile in the boundary layer above a semi-infinite plate can be easily extended to describe Thermal and Concentration boundary layers for heat and mass transfer respectively. Rather than the differential x-momentum balance (equation of motion), this uses a similarly derived Energy and Mass balance:

### Energy:

$${υ}_{x} \frac{\partial T}{\partial x} + {υ}_{y} \frac{\partial T}{\partial y} = \frac{k}{ρC p} \frac{{\partial }^{2} T}{\partial {y}^{2}}$$

### Mass:

$${υ}_{x} \frac{\partial {c}_{A}}{\partial x} + {υ}_{y} \frac{\partial {c}_{A}}{\partial y} = {D}_{AB} \frac{{\partial }^{2} {c}_{A}}{\partial {y}^{2}}$$

For the momentum balance, kinematic viscosity ν can be considered to be the momentum diffusivity. In the energy balance this is replaced by thermal diffusivity α=k/ρC_{P}, and by mass diffusivity D_{AB} in the mass balance. In thermal diffusivity of a substance, k is its thermal conductivity, ρ is its density and C_{P}is its heat capacity. Subscript AB denotes diffusivity of species A diffusing into species B.

Under the assumption that α=D_{AB}=ν, these equations become equivalent to the momentum balance. Thus, for Prandtl number Pr=ν/α=1 and Schmidt number Sc=ν/D_{AB}=1 the Blasius solution applies directly.

Accordingly, this derivation uses a related form of the boundary conditions, replacing v with T or c_{A} (absolute temperature or concentration of species A). The subscript S denotes a surface condition.

$$\frac{{υ}_{x} - {υ}_{S}}{{υ}_{∞} - {υ}_{S}} = \frac{T - {T}_{S}}{{T}_{∞} - {T}_{S}} = \frac{{c}_{A} - {c}_{A S}}{{c}_{A ∞} - {c}_{A S}} = 0$$

at y=0

$$\frac{{υ}_{x} - {υ}_{S}}{{υ}_{∞} - {υ}_{S}} = \frac{T - {T}_{S}}{{T}_{∞} - {T}_{S}} = \frac{{c}_{A} - {c}_{A S}}{{c}_{A ∞} - {c}_{A S}} = 1$$

at y=∞ and χ=0

Using the streamline function Blasius obtained, the following is a solution for the shear stress at the surface of the plate.

$${τ}_{0} = {( \frac{\partial {υ}_{x}}{\partial y} )}_{y = 0} = 0.332 \frac{{υ}_{∞}}{x} {Re}^{1 / 2}$$

And via the boundary conditions, it is known that

$$\frac{{υ}_{x} - {υ}_{S}}{{υ}_{∞} - {υ}_{S}} = \frac{T - {T}_{S}}{{T}_{∞} - {T}_{S}} = \frac{{c}_{A} - {c}_{A S}}{{c}_{A ∞} - {c}_{A S}}$$

We are given the following relations for heat/mass flux out of the surface of the plate

$${( \frac{\partial T}{\partial y} )}_{y = 0} = 0.332 \frac{{T}_{∞} - {T}_{S}}{x} {{Re}^{1 / 2} \\ ( \frac{\partial {c}_{A}}{\partial y} )}_{y = 0} = 0.332 \frac{{c}_{A ∞} - {c}_{A S}}{x} {Re}^{1 / 2}$$

So for Pr=Sc=1

$$δ = {δ}_{T} = {δ}_{c} = \frac{5.0 * x}{\sqrt{Re}}$$

Where δ_{T}, δ_{c} are the regions of flow where T and c_{A} are less than 99% of their far field values.

Because the Prandtl number of a particular fluid is not often unity, German engineer E. Polhausen, who worked with Ludwig Prandtl, attempted to empirically extend these equations to apply for Pr≠1. His results can be applied to Sc as well. He found that for Prandtl number greater than 0.6, the thermal boundary layer thickness was approximately given by:

$$\frac{δ}{{δ}_{T}} = {Pr}^{1 / 3}$$

and therefore

$$\frac{δ}{{δ}_{c}} = {Sc}^{1 / 3}$$

From this solution, it is possible to characterize the convective heat/mass transfer constants based on the region of boundary layer flow. Fourier's law of conduction and Newton's Law of Cooling are combined with the flux term derived above and the boundary layer thickness.

$$\frac{q}{A} = - {k ( \frac{\partial T}{\partial y} )}_{y = 0} = {h}_{x} ( {T}_{S} - {T}_{∞} )$$

$${h}_{x} = 0.332 \frac{k}{x} {Re}_{x}^{1 / 2} {Pr}^{1 / 3}$$

This gives the local convective constant h_{χ} at one point on the semi-infinite plane. Integrating over the length of the plate gives an average

$${h}_{L} = 0.664 \frac{k}{x} {Re}_{L}^{1 / 2} {Pr}^{1 / 3}$$

Following the derivation with mass transfer terms (k=convective mass transfer constant, D_{AB}=diffusivity of species A into species B, Sc=ν/D_{AB}), the following solutions are obtained:

$${k}_{x}^{′} = 0.332 \frac{{D}_{AB}}{x} {Re}_{x}^{1 / 2} {Sc}^{1 / 3}$$

$${k}_{L}^{′} = 0.664 \frac{{D}_{AB}}{x} {Re}_{L}^{1 / 2} {Sc}^{1 / 3}$$

These solutions apply for laminar flow with a Prandtl/Schmidt number greater than 0.6.

### Compressible Flow

One can consult Anderson's “Modern Compressible Flow With Historical Perspective,” chapters 8 and 9, for the differential equations that govern compressible flow. A common method to analyze compressible fluid flow is to create relations between variables that govern the differential equation when the flow is compressible and non-compressible.

$$\begin{matrix}{C}_{L} = \frac{C \text{?}}{\sqrt{1 - {M}_{∞}^{2}}} & {C}_{L} = \frac{L}{\frac{1}{2} {ρ}_{∞} {V}_{∞}^{2} S} \\ {C}_{M} = \frac{C }{\sqrt{1 - {M}_{∞}^{2}}} & {C}_{M} = \frac{M}{\frac{1}{2} {ρ}_{∞} {V}_{∞}^{2} Sl}\end{matrix}$$

$$\text{?} \text{indicates text missing or illegible when filed}$$

The above equations represent the standard formula for calculating aerodynamic coefficents.

$$\begin{matrix}{C}_{L} = \frac{L}{\frac{1}{2} {ρ}_{∞} {V}_{∞}^{2} S} & \begin{matrix}{C}_{L} = \frac{C \text{?}}{\sqrt{1 - {M}_{∞}^{2}}}\end{matrix} \\ {C}_{M} = \frac{M}{\frac{1}{2} {ρ}_{∞} {V}_{∞}^{2} Sl} & \begin{matrix}{C}_{M} = \frac{C \text{?}}{\sqrt{1 - {M}_{∞}^{2}}}\end{matrix}\end{matrix}$$

$$\text{?} \text{indicates text missing or illegible when filed}$$

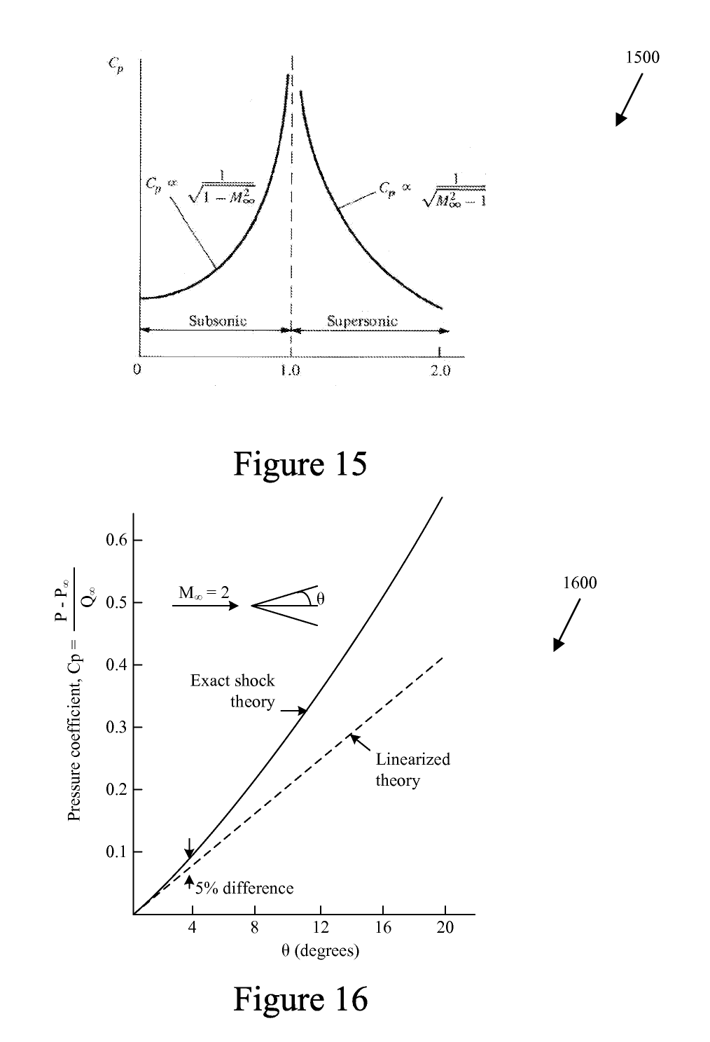

The above equations represent a standard method for transforming the aerodynamic coefficents for compressible flow purpose called the Prandl-Glauert rule. FIG. 15 illustrates an exemplary variation of the linearized pressure coefficient with Mach number according to certain embodiments. FIG. 16 illustrates an exemplary comparison between linearized theory and exact results for pressure on a wedge in supersonic flow according to certain embodiments.

A careful application of certain embodiments of this disclosure at these areas can reduce the transonic separation and help mitigate the shock effects. Because the increase in drag after the craft hits the critical Mach number is so high, certain embodiments of this application can significantly increase the critical Mach number, which can be useful for all craft in the trans-sonic and supersonic regimes.

### General Applicability

As previously mentioned, the teachings of this disclosure may be implemented on any object moving in a fluid (and/or vice versa), such as, for example, land-based vehicles (e.g., trains, cars, tanks, amphibious vehicles, trucks, etc.), aerospace vehicles (e.g., planes of all sizes, rotorcrafts of all sizes, blimps, balloons, jets, rockets, jet engines, re-entry vehicles, etc.), aquatic vehicles (submarines, boats, ships surf boards, wind surfers, etc.), fixed or quasi-fixed structures, (turbines, windmills, deep-sea drilling rigs, buildings, etc.) and so forth.

A boundary layer is present in all objects in a fluid (i.e., regardless of whether the object is moving in the fluid, the fluid is moving over/around/through the object, or a combination of both), and in effect this system works in a similar manner for all objects and any fluid. This system has dual properties in terms of thermal effects and sonic effects, depending on the speed of the object and the viscosity of the fluid. For installations in water, or extreme aerodynamic conditions, components may need to be sealed, protected, and implement methods to increase ruggedness (for dampening vibrations and other inefficiencies). The general implementation in all applications is similar; that is, the technology can be accommodated to the placement on any object. Multiple installations on a vehicle allow for force manipulation dictated by a user or computer. As stated earlier, the mechanical aspect of the system can be installed on any surface ever exposed to a fluid medium (regardless of whether the system and/or the fluid are in motion relative to the installation).

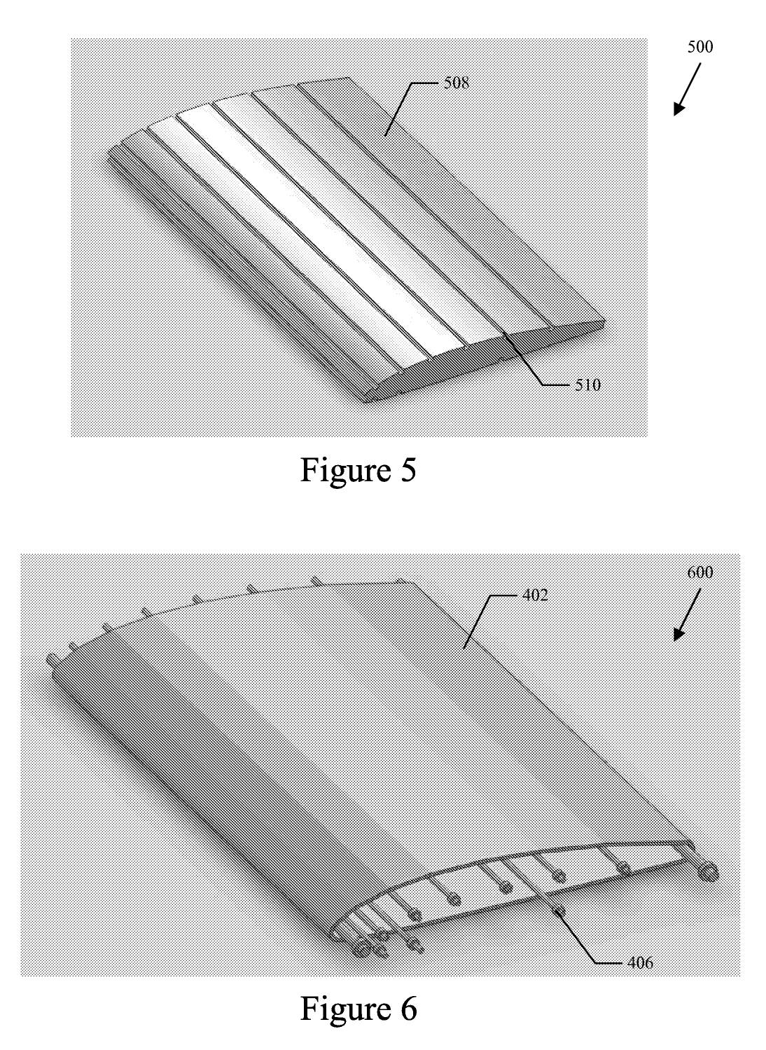

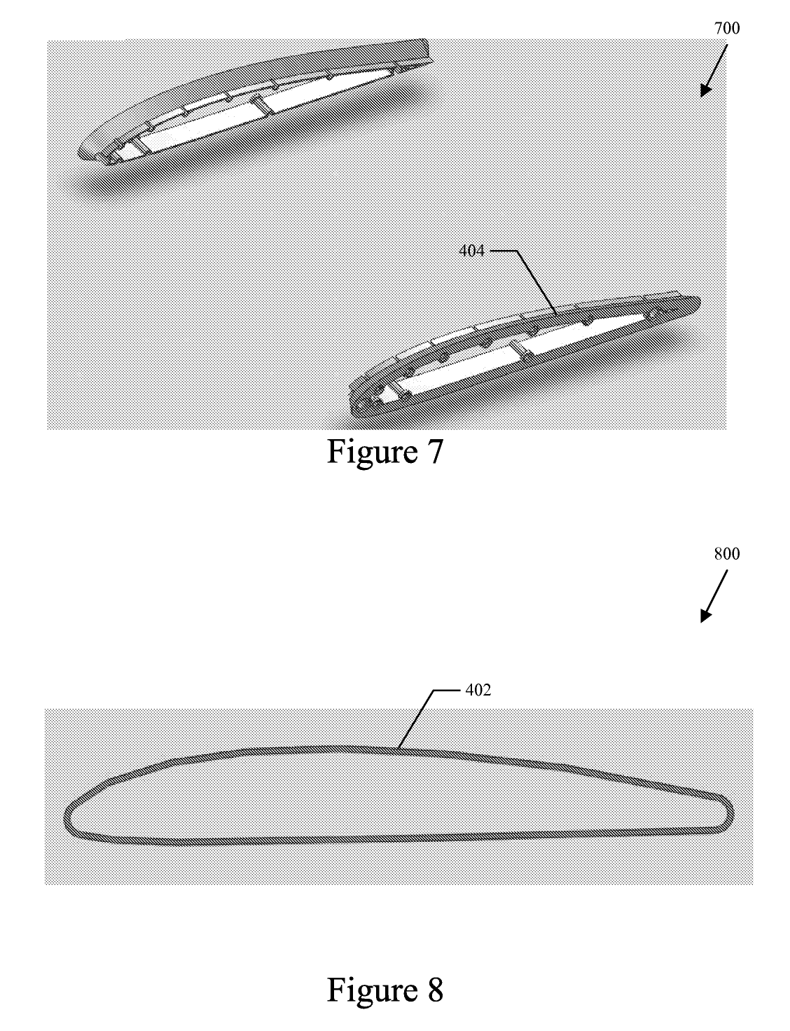

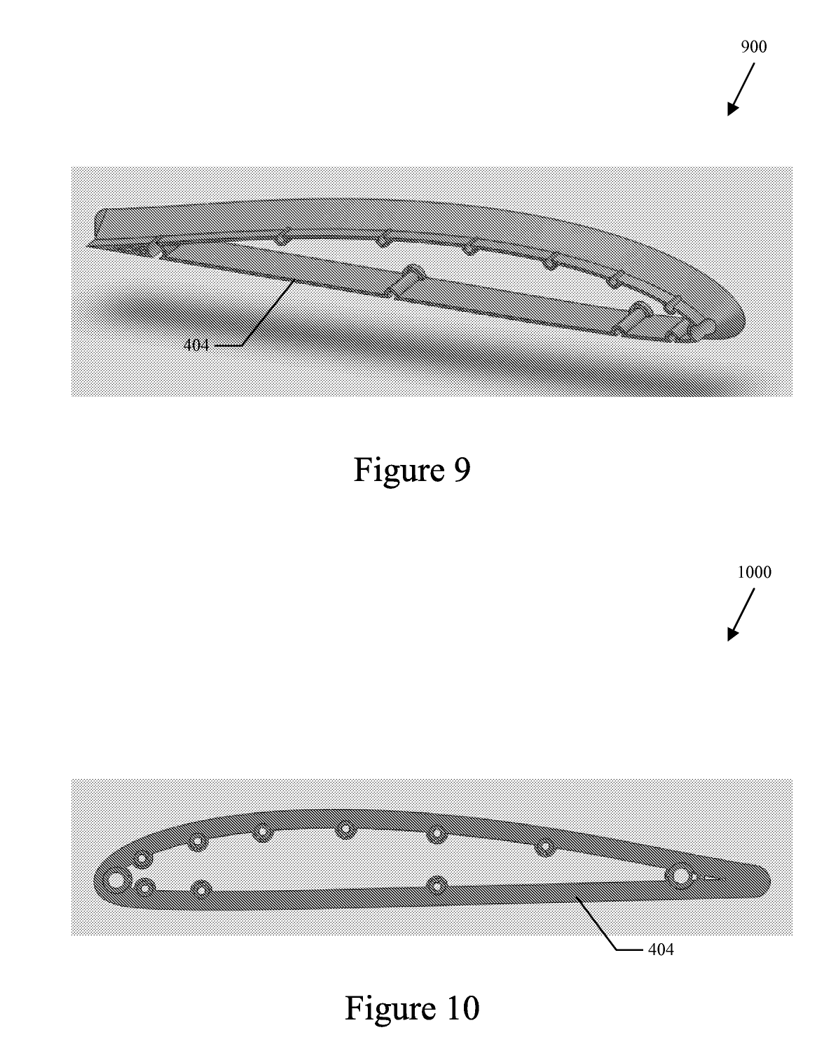

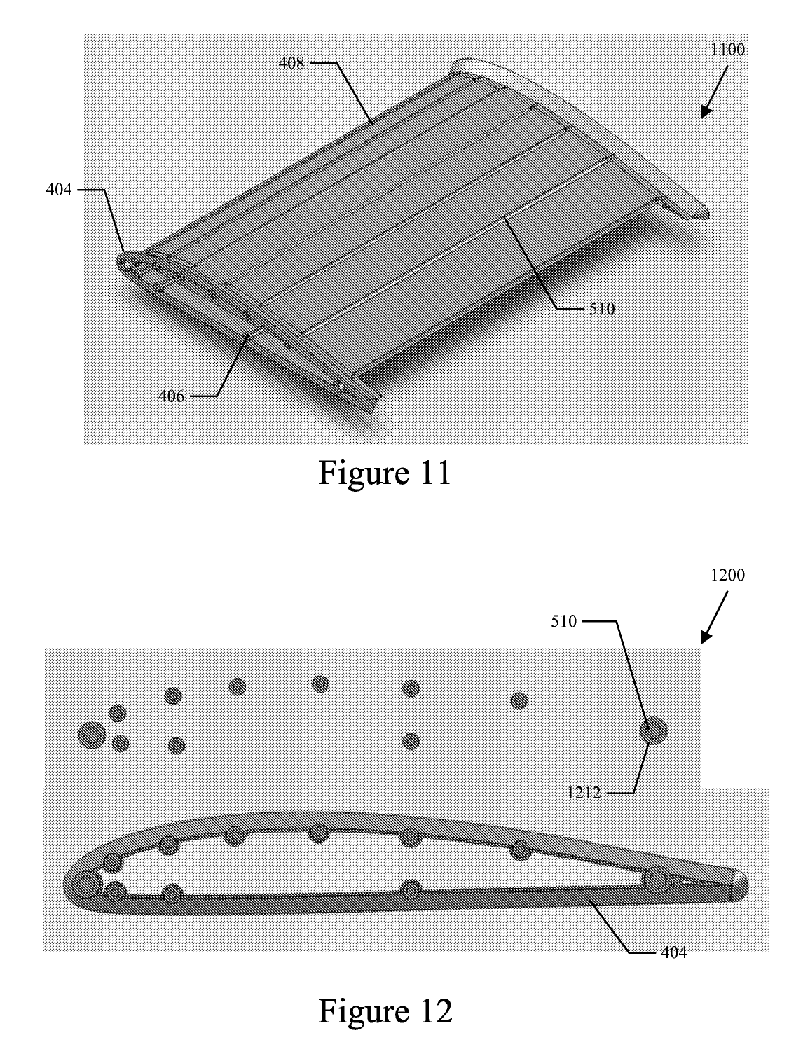

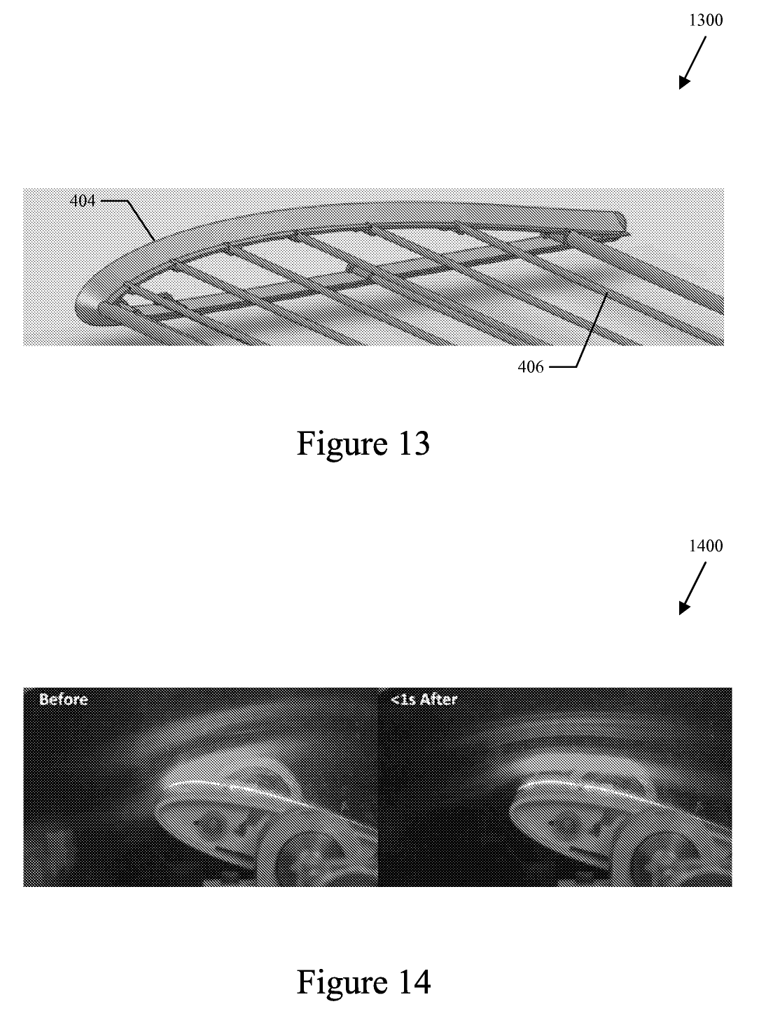

As applied to the wing of an aerospace vehicle, certain embodiments can include a number of general components: a housing or pieces making up a housing, one or more endplates, rods and/or bearings, one or more belt, and motion components (e.g., power source(s), wires, motor(s), control unit, etc.). Various depictions and views of at least some of these components are shown in FIG. 4 through FIG. 13, in which: FIG. 4 illustrates an exemplary device 400 to control flow at a fluid boundary layer according to certain embodiments; FIG. 5 illustrates an exemplary housing 500 according to certain embodiments; FIG. 6 illustrates an exemplary rotational belt and rods 600 according to certain embodiments; FIG. 7 illustrates an exemplary pair of endplates 700 according to certain embodiments; FIG. 8 illustrates an exemplary side view 800 of the rotational belt according to certain embodiments; FIG. 9 is an exemplary isometric view 900 of an endplate according to certain embodiments; FIG. 10 illustrates exemplary alignment holes 1000, which align with cylindrical holes of an aircraft wing housing, according to certain embodiments; FIG. 11 illustrates an exemplary assembly 5100 of bearings inserted into an endplate, coupled to aircraft wing housing, according to certain embodiments; FIG. 12 illustrates an exemplary relationship 1200 between rods, bearings and an endplate according to certain embodiments; and FIG. 13 illustrates an exemplary endplate and rods 1300 according to certain embodiments.

As shown in FIG. 4, device 400 can include a rotational belt 402, one or more endplate 404, and one or more rods 406. Rotational belt 402 may be driven either clockwise or counterclockwise to induce different effects, or may, in certain embodiments, be allowed to rotate freely, without being driven. FIG. 5 illustrates an aircraft wing housing 508 (alternatively referred to as an airfoil) with one or more grooves or slots 510 embedded therein. FIG. 6 illustrates rotational belt 402 and rods 406. FIG. 7 illustrates endplates 404. It will be appreciated that the combination of FIG. 5, FIG. 6, and FIG. 7 (as well as other Figures described in further detail elsewhere in this application) are an exploded view of FIG. 4.

### Rotational Belt

In certain embodiments rendered as an aircraft wing, rotational belt 402 can roll in a variety of formats including but not limited to just on the top of the wing, just on the bottom of the wing, and/or around the entire wing (or portions thereof). Note, although certain embodiments refer to the wing of an aircraft, this application is not intended to be so literally limited (i.e., embodiments could be included on the vertical and/or horizontal stabilizers and/or the fuselage of the aircraft). Rotational belt 402 can rotate over aircraft wing housing 508. Rotation belt 402, regardless of format, does not need to cover the entirety of the wing. It may cover only certain patches whether on top and/or on the bottom. Rotational belt 402 may also be integrated on the main fuselage/hull, or any surface of the aircraft/object exposed to a fluid in all the varied ways mentioned herein. Rotational belt 402 materials can be made of a variety of materials for various purposes, which can be selected based at least on certain factors of each particular installation. Factors that can be considered in choosing rotational belt 402 material(s) include, but are not limited to, roughness (e.g., different aerodynamic characteristics), thermal properties (e.g., for forced convection), elasticity (e.g., morph-able wings/applications), porosity, environment concerns (e.g., salt water, oxidation, etc.), the need for radar/signal jamming, and so on. Rotational belt 402 may be painted or coated for a variety of reasons including aesthetic concerns, advertising or marketing, ruggedness, environmental considerations, and the like. Materials from which rotational belt 402 can be selected include, but are not limited to, sand paper, plastics, urethanes, or rubber. Additionally, rotation belt 402 can be a joined-together construction, which includes one or more segments joined together to form a contiguous and operational rotation belt 402. Such joined-together construction may facilitate, for example, easier installation.

Rotational belt 402 placement and design can be adapted to variable changing geometries (e.g., doors, flaps on wings, and changing wing cross sections). The speed at which rotational belt 402 may rotate is variable and dependent on variety of considerations, for example, object capabilities and mission objectives. For a driven system, any and all movement of rotational belt 402 designates the system as active and working. For a freely-rotating system, rotational belt 402 works in a passive mode. The system may be activated while the object is in any state (moving, stationary, or otherwise). In certain embodiments, rotational belt 402 can be attached tightly around the wing; but a loss-fitting rotational belt 402 can still exhibit the same or similar characteristics. Rotational belt 402 may be either slid onto the rolling mechanism or be attached after the fact, via one or more seams or joints.

In certain embodiments, the belt seam can be attached in a variety of ways. For example, with a rectangular belt, the method for joining at the seam can be done by either bonding via tape, glue, epoxy, solder, weld, melting the two ends together and so on. Also, there are other standard practices used in conveyor belts to maintain thickness of the belt and strength of the connection, which can be equally applicable to this application. Also, the belt may be cut in the shape of diamond, with two vertical edges and two 45 degree angle edges, in which the seam can be the 45 degree angle edges. This shape can make it so that the seam is always rolling over the drive mechanism. If the seam is always present over the drive mechanism, there will be less of a shift in inertia and therefore vibrations in the system.

FIG. 8 shows a side view of the rotational belt 402 and the general shape maintained as the belt rotates around rollers or rods 406 as if tightly installed on a wing. FIG. 6 depicts how the belt interacts with rollers 406. As rods 406 rotate, rotational belt 402 moves. Endplates 404, depicted e.g. in FIG. 7, can house the bearings, and transitively, the ends of rods 406 depicted in FIG. 4. In certain embodiments, one rod is driven by a power plant/motor and other rods may be idle free and to rotate or not rotate as needed. These idle rods are there for the purposes of shaping and supporting the belt into a specific contour, among other things. Also, all rods may be magnetically levitated, or positioned, and the drive mechanism can be chosen given the specific engineering constraints and objectives of each specific installation.

As shown in FIG. 5, isometric view 500 illustrates aircraft wing housing 508, which can have a plurality of linear cuts 510 (e.g., slots, grooves, etc.) that span aircraft wing housing 508. Linear cuts can have, for example, an approximately semi-circular cross-section. Of course, other configurations can be implemented. Linear cuts 510 can span the profile of the installation, tangent to the aircraft wing housing 508 contour. Rotatable rods 406, illustrated in FIG. 4 and FIG. 6, can be placed in linear cuts 510, enabling belts of various materials to roll along the contour of aircraft wing housing 508 shape. The placement and number of cuts is specific to the aircraft wing housing 508 chosen. Various different aircraft wing housing 508 can employ this technology.

### Endplate/Bearings/Rods

FIG. 9, FIG. 10, and FIG. 12 illustrate the relationship between endplates 404, at least one bearing element 1212, and at least one rod 406. FIG. 11 illustrates how these elements fit together with an aircraft wing housing 510. Bearings 1212 and rods 406 can be made of any number of materials, chosen based at least one certain parameters, such as dampen vibration dampening, strength (e.g., tensile, sheer, etc.), environment constraints, and so on. Bearings 1212 can be of any type, roller, needle, self-aligning, magnetic, or other. Rods 406, whose function can include driving and supporting rotational belt 402, may also be round tubes for weight or damping purposes. The placement of rods 406 and bearings 1212 can be arbitrary around the contour of the wing. Rods 406 and bearings 1212 can be embedded and offset from the contour of the wing. In certain embodiments, rods 406 can be placed as close to the wing, or embedded, so that the surfaces of rods 406 are tangent to the contour of the wing. Rods 406 can vary in length, and diameter depending on belt shaping and driving needs for a given design and/or installation.

FIG. 9 is an isometric view 900 of endplate 404 that can be connected to the fuselage of an aircraft, according to one embodiment. As shown in FIG. 9, endplate 404 can house supplemental bearings (not shown) for bearings 1212 and rollers 406. Any type of power source (e.g., motor) can propel one or more rods 406. In certain embodiments, all bearings 1212 and rollers 406 are interference fit into the respective grooves 510 of the aircraft wing housing 508. The final effect can resemble a conveyor belt mechanism where the conveyor belt spins around the contour of the wing, bending and curving around the leading and trailing edges. FIG. 10 shows the endplate 404 holes that line up with the slots 510 in aircraft wing housing 508 (not shown in FIG. 10). FIG. 12 generally shows where the rods 406 and bearings 1212 fit into the endplate 404.

FIG. 11 displays bearings 1212 and rods 406 inserted into the endplate 404. Endplate 404 hold the airfoil in place (or vice versa) while enabling rods 406 to slide horizontally through grooves 510 in the wing housing 508, providing the framework to accommodate rotating belt 402. The horizontal incisions along the wing can be parallel to each other, and objectively spaced, enabling smooth flow of rotating belt 402 over the contours of the airfoil. Endplate 404 is perpendicular (or approximately so) to the airfoil at the points of contact. FIG. 13 illustrates rods 406 and endplate 404 installed in/on each other without rotating belt 402 or wing housing 508.

### Power Source and Control

The piece of equipment that drives one or more of rods 406, and in turn, rotates the belt, is any form of motor or device capable of providing a torque. Additionally, one or more drive rods may be made of a different (e.g., more rotationally sturdy) than the non-drive, freely rotating support rods. Alternatively, one or more motors may drive one or more rotating belts directly (i.e., with rods 406 rotating freely). Multiple power plants can be implemented to drive multiple sets of belts and/or rods on the aircraft. These power plants can have a back shaft to spin belts behind and in front at the same speed. These entities can possess various sensors, which monitor speed, rpm, and power draw. These entities can be connected to gears for the purposes of increasing or decreasing the given rpm range.

In certain embodiments, cylinders can be embedded to minimally protrude from the airfoil profile, while still covering a significant projected surface area, causing the Magnus Effect, because macroscopically, the surface of the wing of an aircraft is moving. By viscous forces and direct contact, the cylinders push the air in the direction they are rotating. On the top surface, the cylinders rotate with the free stream. On the bottom surface, the cylinders rotate against the free stream. Flow separation occurs when the velocity gradient starts to reverse. The tangential velocity of the rotating cylinders is larger than normal (V=0), and therefore, the airfoil is more resistant to reverse flow. In effect, separation is delayed. The higher velocity also engenders less pressure. Theoretically, if the surface of the airfoil is rotating at the free stream velocity, the velocity profile would be a vertical line, and drag due to shear stress in the fluid could be eliminated. The above description of the direction of the rollers is not intended to limit operation or scope of this application, and merely serves as a guide for operation. In summation, increasing the velocity on the top surface of the airfoil, delays separation and reduces pressure. Simultaneously, the velocity on the bottom surface decreases, leading to higher pressure. The net result is increased lift, decreased drag, and delayed stall.

FIG. 14 illustrates an exemplary device 1400 before and after actuation of a rotational belt according to certain embodiments. As shown in FIG. 14, a belt is wrapped around powered cylinders (as contrasted to a belt over rollers, as described in more detail throughout this application) and the air (shown in green) flows over the airfoil. The continuous surface of the belt over the entire wing helps to ensure that the air sticks at all points of contact, thus proving that the air has no chance to separate while being continuously manipulated over the surface of the entire wing. This new type of wing control surface can improve the results of certain embodiments due to increased surface area of contact. The belt rotates with the stream on the top, and against the stream on the bottom causing supplemental increases in lift, decreases in drag, and delay in stall. The specific installation details, speed and direction of rotation, number of belts and so on are not meant to be limiting factors.

### Retrofit Embodiment

In certain embodiments, the techniques described herein serve as an inventive template for those skilled in the art to understand the broader scope of this application and for implementation in all types of objects. Certain embodiments can include rods being held in fixed positions along the outside contour of an object (or, perhaps, within an inside contour of an object, if that inside contour impacts or is impacted by a fluid). The rods can be held by bearings and powered by any kind of suitable rotary power source. A belt can be wrapped around the rods and driven like a conveyor. The key distinction in this implementation, as contrasted to others described elsewhere in this application, is that nothing need be directly embedded into the object. It is simply attached directly to the outside of the object (i.e., as in a retrofit). The size and power requirements vary among objects. It can be governed, for example, by the mission objectives, design constraints and/or environmental considerations of the object, and based at least on the control algorithm, which dictates things like belt speed and rotation direction. It should be noted that compared to other methods of boundary layer control, all of the techniques described herein consume less power. The input for the motor is either manually operated or automated via a computer or other controller means.

It will be appreciated that embodiments of the present teachings may be rendered on any planar surface of a vehicle. For example, in embodiments rendered on an aircraft, the present disclosure may be implemented on a wing, a fuselage, a rudder, an elevator, an aileron, either alone or in any combination. In scope, the present teachings encompass technologies that change the velocity gradient boundary condition on the surface of an object moving in a fluid. The purpose of this disclosure is boundary layer control. This type of control is different from previous solutions because it is intrinsically changing the conditions for the differential equation at hand by changing the velocity gradient. Other similar types of boundary control strategies rely on geometry or changing the pressure to gain such control.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, components, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in one or more software modules executed by one or more processing elements, or in a combination of the two. A software module may reside in RAM memory, flash memory, ROM memory, EPROM memory, EEPROM memory, registers, hard disk, a removable disk, a CD-ROM, or any other form or combination of storage medium known in the art. An example storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples and additional elements may be added.

### Embodiments

A1. An apparatus adapted to control flow of a fluid boundary layer, comprising: an aircraft wing housing, having a chord length, a leading edge and a trailing edge; at least one bearing element, disposed on an interior portion of the aircraft wing housing, disposed between a first endplate and a second endplate, substantially parallel to the chord length of the aircraft wing housing; at least one rod member, adapted to fit into the at least one bearing element, extending substantially parallel to the chord length of the aircraft wing housing; and a rotational belt, disposed on an outer surface of the aircraft wing housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer.

A2. The apparatus of embodiment A1, further comprising a power source, wherein the power source is adapted to deliver rotational force to the at least one rod member thereby rotating the rotational belt.

A3. The apparatus of embodiment A1, wherein the rotational belt is actuated when a tangential velocity of an airstream at the fluid boundary layer exceeds a predetermined velocity operating on the outer surface of the rotational belt, wherein the predetermined velocity is determined in part by the second coefficient of friction, such that a rotational inertia of the rotational belt is overcome, thereby actuating the rotational belt circumferentially.

A4. The apparatus of embodiment A2, wherein the rotational belt is actuated when the power source operates to provide rotational force to the at least one rod member.

A5. The apparatus of embodiment A4, further comprising a velocity gradient sensor element operatively coupled to the aircraft wing housing and a microprocessor element, wherein the velocity gradient sensor element detects a velocity gradient at the fluid boundary layer and transmits a detected velocity gradient to the microprocessor element.

A6. The apparatus of embodiment A5, wherein the microprocessor element is operatively coupled to the power source and operates to control the delivered rotational force from the power source to the at least one rod member.

A7. The apparatus of embodiment A5, further comprising an accelerometer operatively coupled to the microprocessor.

A8. The apparatus according to any of embodiments A5-A7, alone or in any combination, further comprising a particle tracking sensor operatively coupled to the microprocessor.

A9. The apparatus according to any of embodiments A5-A8, alone or in any combination, further comprising a flow sensor operatively coupled to the microprocessor.

A10. The apparatus according to any of embodiments A5-A9, alone or in any combination, further comprising a stall angle sensor operatively coupled to the microprocessor.

A11. The apparatus according to any of embodiments A5-A10, alone or in any combination, further comprising a gyroscope sensor operatively coupled to the microprocessor.

A12. The apparatus according to any of embodiments A5-A11, alone or in any combination, further comprising an altimeter sensor operatively coupled to the microprocessor.

B1. A method of controlling a fluid velocity at a fluid boundary layer of a plane on a surface of a housing, comprising the steps of: determining an initial fluid velocity at the fluid boundary layer of the plane; providing at least one bearing element, operatively coupled to at least one rod member, disposed on an interior portion of the housing; providing a rotational belt, operatively coupled to the at least one rod member; providing a power source, mechanically coupled to the at least one rod member, wherein the power source operates to deliver a rotational force to the at least one rod member; and rotating the rotational belt at a control velocity.

C1. An apparatus for controlling a fluid boundary layer of an aircraft surface, comprising: an aircraft surface housing; at least one bearing element, disposed on an interior portion of the aircraft surface housing, disposed between a first endplate and a second endplate; at least one rod member, adapted to fit into the at least one bearing element; and a rotational belt, disposed on an outer surface of the aircraft surface housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer.

C2. The apparatus of embodiment C1, further comprising a power source, wherein the power source is adapted to deliver rotational force to the at least one rod member thereby rotating the rotational belt.

C3. The apparatus of embodiment C1, wherein the rotational belt is actuated when a tangential velocity of an airstream at the fluid boundary layer exceeds a predetermined velocity operating on the outer surface of the rotational belt, wherein the predetermined velocity is determined in part by the second coefficient of friction, such that a rotational inertia of the rotational belt is overcome, thereby actuating the rotational belt circumferentially.

C4. The apparatus of embodiment C2, wherein the rotational belt is actuated when the power source operates to provide rotational force to the at least one rod member.

C5. The apparatus of embodiment C4, further comprising a velocity gradient sensor element operatively coupled to the aircraft surface housing and a microprocessor element, wherein the velocity gradient sensor element detects a velocity gradient at the fluid boundary layer and transmits a detected velocity gradient to the microprocessor element.

C6. The apparatus of embodiment C5, wherein the microprocessor element is operatively coupled to the power source and operates to variably control the delivered rotational force from the power source to the at least one rod member.

C7. The apparatus according to any of embodiments C1-C6, alone or in any combination, wherein the aircraft surface housing comprises a fuselage.

C8. The apparatus according to any of embodiments C1-C7, alone or in any combination, wherein the aircraft surface housing comprises a wing.

C9. The apparatus according to any of embodiments C1-C8, alone or in any combination, wherein the aircraft surface housing comprises a rudder.

C10. The apparatus according to any of embodiments C1-C9, alone or in any combination, wherein the aircraft surface housing comprises a vertical stabilizer.

C11. The apparatus according to any of embodiments C1-C10, alone or in any combination, wherein the aircraft surface housing comprises an aileron.

C12. The apparatus according to any of embodiments C1-C11, alone or in any combination, wherein the aircraft surface housing comprises an elevator.

D1. An apparatus for controlling a fluid boundary layer of at least a portion of a vehicle body surface, comprising: a vehicle body surface housing; at least one bearing element, disposed on an interior portion of the vehicle body surface housing, disposed between a first endplate and a second endplate; at least one rod member, adapted to fit into the at least one bearing element; and a rotational belt, disposed on an outer surface of the vehicle body surface housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer.

D2. The apparatus of embodiment D1, further comprising a power source, wherein the power source is adapted to deliver rotational force to the at least one rod member thereby rotating the rotational belt.

D3. The apparatus of embodiment D1, wherein the rotational belt is actuated when a tangential velocity of a fluid stream at the fluid boundary layer exceeds a predetermined velocity operating on the outer surface of the rotational belt, wherein the predetermined velocity is determined in part by the second coefficient of friction, such that a rotational inertia of the rotational belt is overcome, thereby actuating the rotational belt circumferentially.

D4. The apparatus of embodiment D2, wherein the rotational belt is actuated when the power source operates to provide rotational force to the at least one rod member.

D5. The apparatus of embodiment D4, further comprising a velocity gradient sensor element operatively coupled to the vehicle body surface housing and a microprocessor element, wherein the velocity gradient sensor element detects a velocity gradient at the fluid boundary layer and transmits a detected velocity gradient to the microprocessor element.

D6. The apparatus of embodiment D5, wherein the microprocessor element is operatively coupled to the power source and operates to variably control the delivered rotational force from the power source to the at least one rod member.

D7. The apparatus according to any of embodiments D1-D6, alone or in any combination, wherein the vehicle body surface housing comprises a motorcycle element.

D8. The apparatus according to any of embodiments D1-D6, alone or in any combination, wherein the vehicle body surface comprises a sedan element.

D9. The apparatus according to any of embodiments D1-D6, alone or in any combination, wherein the vehicle body surface comprises a tank element.

D10. The apparatus according to any of embodiments D1-D6, alone or in any combination, wherein the vehicle body surface comprises a truck element.

D11. The apparatus according to any of embodiments D1-D6, alone or in any combination, wherein the vehicle body surface comprises a boat element.

D12. The apparatus according to any of embodiments D1-D6, alone or in any combination, wherein the vehicle body surface comprises a submarine element.

D13. The apparatus according to any of embodiments D1-D6, alone or in any combination, wherein the vehicle body surface comprises a rocket element.

D14. The apparatus according to any of embodiments D1-D6, alone or in any combination, wherein the vehicle body surface comprises a rotorcraft element.

D15. The apparatus according to any of embodiments D1-D6, alone or in any combination, wherein the vehicle body surface comprises a helicopter element.

D16. The apparatus according to any of embodiments D1-D6, alone or in any combination, wherein the vehicle body surface comprises a blimp element.

D17. The apparatus according to any of embodiments D5-D16, alone or in any combination, further comprising an accelerometer operatively coupled to the microprocessor.

D18. The apparatus according to any of embodiments D5-D17, alone or in any combination, further comprising a particle tracking sensor operatively coupled to the microprocessor.

D19. The apparatus according to any of embodiments D5-D18, alone or in any combination, further comprising a flow sensor operatively coupled to the microprocessor.

D20. The apparatus according to any of embodiments D5-D19, alone or in any combination, further comprising a stall angle sensor operatively coupled to the microprocessor.

D21. The apparatus according to any of embodiments D5-D20, alone or in any combination, further comprising a gyroscope sensor operatively coupled to the microprocessor.

D22. The apparatus according to any of embodiments D5-D21, alone or in any combination, further comprising an altimeter sensor operatively coupled to the microprocessor.

E1. An apparatus for controlling a fluid boundary layer of at least a portion of a turbine element surface, comprising: a turbine surface housing; at least one bearing element, disposed on an interior portion of the turbine surface housing, disposed between a first endplate and a second endplate; at least one rod member, adapted to fit into the at least one bearing element; and a rotational belt, disposed on an outer surface of the turbine surface housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer.

E2. The apparatus of embodiment E1, further comprising a power source, wherein the power source is adapted to deliver rotational force to the at least one rod member thereby rotating the rotational belt.

E3. The apparatus of embodiment E1, wherein the rotational belt is actuated when a tangential velocity of a fluid stream at the fluid boundary layer exceeds a predetermined velocity operating on the outer surface of the rotational belt, wherein the predetermined velocity is determined in part by the second coefficient of friction, such that a rotational inertia of the rotational belt is overcome, thereby actuating the rotational belt circumferentially.

E4. The apparatus of embodiment E2, wherein the rotational belt is actuated when the power source operates to provide rotational force to the at least one rod member.

E5. The apparatus of embodiment E4, further comprising a velocity gradient sensor element operatively coupled to the turbine surface housing and a microprocessor element, wherein the velocity gradient sensor element detects a velocity gradient at the fluid boundary layer and transmits a detected velocity gradient to the microprocessor element.

E6. The apparatus of embodiment E5, wherein the microprocessor element is operatively coupled to the power source and operates to variably control the delivered rotational force from the power source to the at least one rod member.

E7. The apparatus according to any of embodiments E1-E6, alone or in any combination, wherein the turbine surface housing comprises a windmill element.

E8. The apparatus according to any of embodiments E1-E6, alone or in any combination, wherein the turbine surface housing comprises a space flight re-entry vehicle element.

F1. An apparatus for controlling a fluid boundary layer of a portion of a vehicle body surface, comprising: an external vehicle body surface housing; at least one bearing element, disposed on an interior portion of the external vehicle body surface housing, disposed between a first endplate and a second endplate; at least one rod member, adapted to fit into the at least one bearing element; and a rotational belt, disposed on an outer surface of the external vehicle body surface housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer.

F2. The apparatus of embodiment F1, further comprising a power source, wherein the power source is adapted to deliver rotational force to the at least one rod member thereby rotating the rotational belt.

F3. The apparatus of embodiment F1, wherein the rotational belt is actuated when a tangential velocity of a fluid stream at the fluid boundary layer exceeds a predetermined velocity operating on the outer surface of the rotational belt, wherein the predetermined velocity is determined in part by the second coefficient of friction, such that a rotational inertia of the rotational belt is overcome, thereby actuating the rotational belt circumferentially.

F4. The apparatus of embodiment F2, wherein the rotational belt is actuated when the power source operates to provide rotational force to the at least one rod member.

F5. The apparatus of embodiment F4, further comprising a velocity gradient sensor element operatively coupled to the external vehicle body surface housing and a microprocessor element, wherein the velocity gradient sensor element detects a velocity gradient at the fluid boundary layer and transmits a detected velocity gradient to the microprocessor element.

F6. The apparatus of embodiment F5, wherein the microprocessor element is operatively coupled to the power source and operates to variably control the delivered rotational force from the power source to the at least one rod member.

F7. The apparatus according to any of embodiments F1-F6, alone or in any combination, wherein the external vehicle body surface housing comprises a motorcycle element.

F8. The apparatus according to any of embodiments F1-F6, alone or in any combination, wherein the external vehicle body surface housing comprises a sedan element.

F9. The apparatus according to any of embodiments F1-F6, alone or in any combination, wherein the external vehicle body surface housing comprises a tank element.

F10. The apparatus according to any of embodiments F1-F6, alone or in any combination, wherein the external vehicle body surface housing comprises a truck element.

F11. The apparatus according to any of embodiments F1-F6, alone or in any combination, wherein the external vehicle body surface housing comprises a boat element.

F12. The apparatus according to any of embodiments F1-F6, alone or in any combination, wherein the external vehicle body surface housing comprises a submarine element.

F13. The apparatus according to any of embodiments F1-F6, alone or in any combination, wherein the external vehicle body surface housing comprises a rocket element.

F14. The apparatus according to any of embodiments F1-F6, alone or in any combination, wherein the external vehicle body surface housing comprises a rotorcraft element.

F15. The apparatus according to any of embodiments F1-F6, alone or in any combination, wherein the external vehicle body surface housing comprises a helicopter element.

F16. The apparatus according to any of embodiments F1-F6, alone or in any combination, wherein the external vehicle body surface housing comprises a blimp element.

G1. An apparatus for controlling a thermal property at a fluid boundary layer of at least a portion of a vehicle body surface, comprising: a vehicle body surface housing; at least one bearing element, disposed on an interior portion of the vehicle body surface housing, disposed between a first endplate and a second endplate; at least one rod member, adapted to fit into the at least one bearing element; a rotational belt, disposed on an outer surface of the vehicle body surface housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer; and a thermal sensor, operatively coupled to the vehicle body surface housing, adapted to detect at least one thermal property of the vehicle body surface housing.

G2. The apparatus of embodiment G1, further comprising a power source, wherein the power source is adapted to deliver rotational force to the at least one rod member thereby rotating the rotational belt.

G3. The apparatus of embodiment G1, wherein the rotational belt is actuated when a tangential velocity of a fluid stream at the fluid boundary layer exceeds a predetermined velocity operating on the outer surface of the rotational belt, wherein the predetermined velocity is determined in part by the second coefficient of friction, such that a rotational inertia of the rotational belt is overcome, thereby actuating the rotational belt circumferentially.

G4. The apparatus of embodiment G2, wherein the rotational belt is actuated when the power source operates to provide rotational force to the at least one rod member.

G5. The apparatus of embodiment G4, further comprising a microprocessor element, wherein the thermal sensor transmits the detected at least one thermal property of the vehicle body surface housing to the microprocessor element.

G6. The apparatus of embodiment G5, wherein the microprocessor element is operatively coupled to the power source and operates to variably control the delivered rotational force from the power source to the at least one rod member, thereby controlling the at least one thermal property of the vehicle body surface housing.

H1. An apparatus for controlling an acoustic property at a fluid boundary layer of at least a portion of a vehicle body surface, comprising: a vehicle body surface housing; at least one bearing element, disposed on an interior portion of the vehicle body surface housing, disposed between a first endplate and a second endplate; at least one rod member, adapted to fit into the at least one bearing element; a rotational belt, disposed on an outer surface of the vehicle body surface housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer; and an acoustic sensor, operatively coupled to the vehicle body surface housing, adapted to detect at least one acoustic property of the vehicle body surface housing.

H2. The apparatus of embodiment H1, further comprising a power source, wherein the power source is adapted to deliver rotational force to the at least one rod member thereby rotating the rotational belt.

H3. The apparatus of embodiment H1, wherein the rotational belt is actuated when a tangential velocity of a fluid stream at the fluid boundary layer exceeds a predetermined velocity operating on the outer surface of the rotational belt, wherein the predetermined velocity is determined in part by the second coefficient of friction, such that a rotational inertia of the rotational belt is overcome, thereby actuating the rotational belt circumferentially.

H4. The apparatus of embodiment H2, wherein the rotational belt is actuated when the power source operates to provide rotational force to the at least one rod member.

H5. The apparatus of embodiment H4, further comprising a microprocessor element, wherein the acoustic sensor transmits the detected at least one acoustic property of the vehicle body surface housing to the microprocessor element.

H6. The apparatus of embodiment H5, wherein the microprocessor element is operatively coupled to the power source and operates to variably control the delivered rotational force from the power source to the at least one rod member, thereby controlling the at least one acoustic property of the vehicle body surface housing.

What is claimed is:

1. An apparatus adapted to control flow of a fluid boundary layer, comprising:
an aircraft wing housing, having a chord length, a leading edge and a trailing edge;
at least one bearing element, disposed on an interior portion of the aircraft wing housing, disposed between a first endplate and a second endplate, substantially parallel to the chord length of the aircraft wing housing;
at least one rod member, adapted to fit into the at least one bearing element, extending substantially perpendicular to the chord length of the aircraft wing housing, and;
a rotational belt, disposed on an outer surface of the aircraft wing housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer.

2. The apparatus of claim 1, further comprising a power source, wherein the power source is adapted to deliver a rotational force to the at least one rod member.

3. The apparatus of claim 1, wherein the rotational belt is actuated when a tangential velocity of an airstream at the fluid boundary layer exceeds a predetermined velocity operating on the outer surface of the rotational belt, wherein the predetermined velocity is determined at least in part by the second coefficient of friction, such that a rotational inertia of the rotational belt is overcome, thereby actuating the rotational belt.

4. The apparatus of claim 2, wherein the rotational belt is actuated when the power source operates to provide rotational force to the at least one rod member.

5. The apparatus of claim 4, further comprising:
a velocity gradient sensor element operatively coupled to the aircraft wing housing; and
a microprocessor element,
wherein the velocity gradient sensor element detects a velocity gradient at the fluid boundary layer and transmits a detected velocity gradient to the microprocessor element.

6. The apparatus of claim 5, wherein the microprocessor element is operatively coupled to the power source and operates to control the delivered rotational force from the power source to the at least one rod member.

7. The apparatus of claim 5, further comprising an accelerometer operatively coupled to the microprocessor.

8. A method of controlling a fluid velocity at a fluid boundary layer of a plane on a surface of a housing, comprising the steps of:
determining an initial fluid velocity at the fluid boundary layer of the plane;
providing at least one bearing element, operatively coupled to at least one rod member, disposed on an interior portion of the housing;
providing a rotational belt, operatively coupled to the at least one rod member;
providing a power source, mechanically coupled to the at least one rod member, wherein the power source operates to deliver a rotational force to the at least one rod member; and
rotating the rotational belt at a control velocity.

9. An apparatus for controlling a fluid boundary layer of at least a portion of a vehicle body surface, comprising:
a vehicle body surface housing;
at least one bearing element, disposed on an interior portion of the vehicle body surface housing, disposed between a first endplate and a second endplate;
at least one rod member, adapted to fit into the at least one bearing element; and
a rotational belt, disposed on an outer surface of the vehicle body surface housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer.

10. The apparatus of claim 9, further comprising a power source, wherein the power source is adapted to deliver rotational force to the at least one rod member thereby rotating the rotational belt.

11. The apparatus of claim 9, wherein the rotational belt is actuated when a tangential velocity of a fluid stream at the fluid boundary layer exceeds a predetermined velocity operating on the outer surface of the rotational belt, wherein the predetermined velocity is determined in part by the second coefficient of friction, such that a rotational inertia of the rotational belt is overcome, thereby actuating the rotational belt circumferentially.

12. The apparatus of claim 10, wherein the rotational belt is actuated when the power source operates to provide rotational force to the at least one rod member.

13. The apparatus of claim 12, further comprising:
a velocity gradient sensor element operatively coupled to the vehicle body surface housing; and
a microprocessor element,
wherein the velocity gradient sensor element detects a velocity gradient at the fluid boundary layer and transmits a detected velocity gradient to the microprocessor element.

14. The apparatus of claim 13, wherein the microprocessor element is operatively coupled to the power source and operates to variably control the delivered rotational force from the power source to the at least one rod member.

15. An apparatus for controlling at least one of a thermal property or an acoustic property at a fluid boundary layer of at least a portion of a vehicle body surface, comprising:
a vehicle body surface housing;
at least one bearing element, disposed on an interior portion of the vehicle body surface housing, disposed between a first endplate and a second endplate;
at least one rod member, adapted to fit into the at least one bearing element;
a rotational belt, disposed on an outer surface of the vehicle body surface housing, having an inner surface comprising a first coefficient of friction and an outer surface comprising a second coefficient of friction, wherein the inner surface is operationally coupled to the at least one rod member and the outer surface of the rotational belt is in mechanical contact with the fluid boundary layer; and
at least one of:
a thermal sensor, operatively coupled to the vehicle body surface housing, adapted to detect at least one thermal property of the vehicle body surface housing, or
an acoustic sensor, operatively coupled to the vehicle body surface housing, adapted to detect at least one acoustic property of the vehicle body surface housing.

16. The apparatus of claim 15, further comprising a power source, wherein the power source is adapted to deliver rotational force to the at least one rod member thereby rotating the rotational belt.

17. The apparatus of claim 15, wherein the rotational belt is actuated when a tangential velocity of a fluid stream at the fluid boundary layer exceeds a predetermined velocity operating on the outer surface of the rotational belt, wherein the predetermined velocity is determined in part by the second coefficient of friction, such that a rotational inertia of the rotational belt is overcome, thereby actuating the rotational belt circumferentially.

18. The apparatus of claim 16, wherein the rotational belt is actuated when the power source operates to provide rotational force to the at least one rod member.

19. The apparatus of claim 18, further comprising a microprocessor element, wherein the at least one thermal sensor or the at least one acoustic sensor transmits the detected at least one thermal property or at least one acoustic property, respectively, of the vehicle body surface housing to the microprocessor element.

20. The apparatus of claim 19, wherein the microprocessor element is operatively coupled to the power source and operates to variably control the delivered rotational force from the power source to the at least one rod member, thereby controlling the at least one thermal property or the at least one acoustic property of the vehicle body surface housing.
